(19) United States
(12) Patent Application Publication
(10) Pub. No.: US 2008/0101545 A1
(43) Pub. Date: May 1, 2008

(54) Radiation Screen For An X-Ray Device

(75) Inventor: Robert Petrik, Friedenfels (DE)

Correspondence Address: BRINKS HOFER GILSON & LIONE, P.O. BOX 10395, CHICAGO, IL, 60610, US

(73) Assignee: SIEMENS AKTIENGESELLSCHAFT, Munchen (DE)

(21) Appl. No.: 11/795,230

(22) PCT Filed: Jun. 12, 2006
(86) PCT No.: PCT/EP06/63093

§ 371 Date: Jul. 13, 2007

(30) Foreign Application Priority Data
Jun. 17, 2005 (DE) 10 2005 028 208.3

(51) Int. Cl. G21K 1/02

(52) U.S. Cl. 378/148

(57) ABSTRACT

The invention relates to a radiation screen (30) for an X-ray device (1), comprising at least one radiation limiting means which is displaceably mounted and is embodied as a diaphragm. According to the invention, the radiation limiting means is displaceably mounted on a plane in a perpendicular manner in relation to a defining bundle of rays (6), and comprises a plurality of differently shaped diaphragm apertures (40 . . . 51, 60 . . . 66) for continuously limiting the different bundle of rays (6). It can, for example, be embodied as an essentially rotation-symmetrical perforated disk. In another embodiment, the radiation screen comprises two radiation defining means which are arranged in an overlapping manner in the direction of the bundle of rays (6) which are to be defined.

The present patent document is a nationalization of PCT Application Serial Number PCT/EP2006/063093, filed Jun. 12, 2006, designating the United States, which is hereby incorporated by reference. This application also claims the benefit of DE 10 2005 028 208.3, filed Jun. 17, 2005, which is hereby incorporated by reference.

### BACKGROUND

The present embodiments relate to a radiation diaphragm for an x-ray facility and an x-ray facility with such a radiation diaphragm.

Radiation diaphragms are used in x-ray facilities to narrow an x-ray beam produced by an x-ray tube to form a useful beam. Regions outside the useful beam are masked out by the radiation diaphragm, so that the radiation diaphragm's form decides the residual contour of the useful beam. It is expedient to vary the contour as a function of the respective task. When examining patients or bodies, the aim is to achieve a contour of the useful beam that is tailored to the volume to be examined, to avoid exposing the surrounding region to an unnecessary radiation dose.

Radiation diaphragms disposed in the immediate proximity of the x-ray tube are also referred to as primary radiation diaphragms. Primary radiation diaphragms frequently have a number of individual diaphragms, disposed at different distances from the x-ray tube. The x-ray beam is initially roughly narrowed by a diaphragm disposed first in the beam path, sometimes referred to as a collimator, which brings about an approximately rectangular definition of the beam by one or two pairs of diaphragm plates. Finer definition of the beam path, the contour of which is not necessarily set as rectangular in form, then takes place by a similarly adjustable diaphragm disposed in the beam path.

EP 0 485 742 discloses a further diaphragm that can be embodied as an iris diaphragm. Generally, iris diaphragms produce an approximately circular definition of the x-ray beam. The diameter or typical size of the x-ray beam can be adjusted extremely finely, usually in a continuous manner. Iris diaphragms have a relatively large number of moving parts. Iris diaphragms are complex to construct and expensive to produce. Iris diaphragms have louvers, which are mounted in a displaceable manner and bring about the actual masking of regions of the x-ray beam that are not of interest. The louvers themselves and also their mounting are susceptible to damage due to the louver movement.

BE 100 9333 discloses a radiation diaphragm for a portable x-ray facility. The radiation diaphragm is designed as a perforated diaphragm. The radiation diaphragm has a radiation defining device, formed as a cylinder and disposed concentrically in relation to the x-ray tube. The radiation diaphragm has a plurality of diaphragm apertures, each being able to be positioned by rotating the radiation defining means in front of the beam emission window. The cylindrical form of the radiation defining means has to be tailored to the x-ray tube, around which it is disposed. The radiation defining means cannot be disposed freely but requires an arrangement that is concentric to the x-ray tube. This arrangement requires a complex rotational mounting, since the x-ray tube is disposed in the center of the radiation defining means, where a rotation axis should advantageously be disposed.

### SUMMARY

The present embodiments may obviate one or more of the drawbacks or limitations inherent in the related art. A radiation diaphragm allows fine adjustment of the contour of the useful beam, but which is at the same time simple to construct and economical to produce. An x-ray facility may have such a radiation diaphragm.

In one embodiment, a radiation diaphragm includes at least one radiation defining device mounted in a displaceable manner. The radiation diaphragm is embodied as a perforated diaphragm, which is mounted in a displaceable manner in a plane perpendicular to a beam to be limited, and which has a plurality of differently formed diaphragm apertures for the respectively differently contoured definition of the beam. The arrangement and mounting of the radiation defining device is independent to the greatest possible extent of the form and position of the x-ray tube producing the beam. The form and mounting can be designed as simply as possible, thereby also keeping production costs low. A perforated diaphragm can also be produced particularly simply, compared with an iris diaphragm.

In one embodiment, the radiation defining device is mounted in a rotatable manner in the plane perpendicular to the beam. A rotational mounting can, for example, be realized with little outlay in the form of a simple rotation axis. Rotational movement can be driven and controlled in a simple manner.

In one embodiment, the radiation defining device is a perforated disk with a round periphery. The space requirement of a circular disk is small, in particular during rotational movement of the circular disk.

In one embodiment, the radiation diaphragm has at least two radiation defining devices. The at least two radiation defining devices are disposed in a mutually overlapping manner in the direction of the beam. The required, differently formed diaphragm apertures can be distributed over more than one radiation defining device. This allows a space-saving arrangement of the diaphragm apertures on the respective radiation defining device, so that a smaller periphery results, in particular in the case of the round radiation defining device, and the overall surface can be utilized in a more optimum manner. To double the number of diaphragm apertures, which have to be disposed on an identical radius of a round perforated disk, it would be necessary approximately to double the perforated disk radius (because circumference=2*π*r), with the surface content of the perforated disk however being quadrupled (because surface=π*r²). However, if the double number of diaphragm apertures is distributed over two perforated disks, there is only a doubling of the overall surface of the perforated disks. The radiation defining devices are disposed in an overlapping manner, thereby reducing their overall surface extension by the sum of the mutual overlap.

In one embodiment, the radiation defining devices disposed in a mutually overlapping manner has at least two diaphragm apertures, each being able to be disposed completely within the periphery of at least one diaphragm aperture of the other radiation defining device. The diaphragm apertures can be positioned so that the beam passes through a diaphragm aperture of each radiation defining device and gives the greatest possible diversity of variation for the contours of the defined beam to be achieved.

### BRIEF DESCRIPTION OF THE DRAWINGS

FIG. 1 illustrates an x-ray facility with radiation diaphragm,

FIG. 2 illustrates a first flat disk of the radiation diaphragm,

FIG. 3 illustrates a second perforated disk of radiation diaphragm,

FIG. 4 illustrates a mutually overlapping arrangement of the perforated disks to achieve a first diaphragm aperture,

FIG. 5 illustrates a mutually overlapping arrangement of the perforated disks to achieve a second diaphragm aperture,

FIG. 6 illustrates a mutually overlapping arrangement of the perforated disks to achieve a third diaphragm aperture

FIG. 7 illustrates a mutually overlapping arrangement of the perforated disks to achieve a fourth diaphragm aperture.

### DETAILED DESCRIPTION

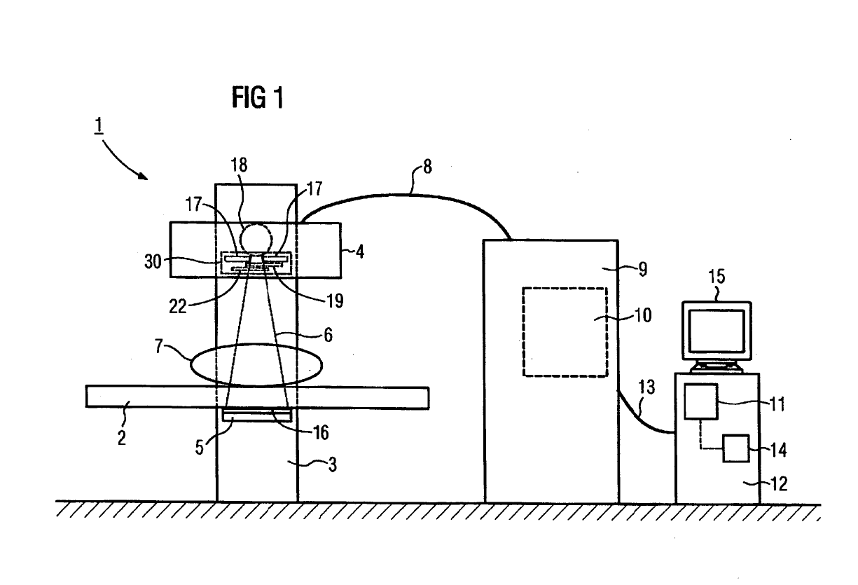

FIG. 1 shows a schematic diagram of an x-ray facility 1 with a radiation diaphragm 30. A patient to be examined 7 is supported on a patient bed 2. Below the patient bed 2 is an image receiver 5 along with associated scattered radiation grids 16 for recording x-ray images. The patient bed 2 is attached to a gantry 3. An x-ray radiation source 4 is attached to the gantry 3. The x-ray radiation source 4 has an x-ray tube 18 for producing x-ray radiation and a (conventional) primary diaphragm 17 for rough definition of the x-ray beam 6. The primary diaphragm 17 has two diaphragm plates, allowing an essentially right-angled definition. After passing through the primary diaphragm 17, the x-ray beam 6 is defined further to the required contour by the perforated disks 19 and 22, which together form a space-saving and structurally simple second radiation diaphragm. It is possible to achieve contours that are not rectangular and to set a number of dimensions for the contour. The primary diaphragm 17 and the second diaphragm formed by the perforated disks 19 and 22 together form the radiation diaphragm 30.

The x-ray radiation source 4 and radiation diaphragm 30 are supplied with the necessary operating voltage and control signals by a supply line 8. The necessary electrical signals are supplied by a switchgear cabinet 9, which has a high voltage generator 10 that generates the x-ray voltage required to operate the x-ray tube 18 in addition to switching means (not shown) for generating the control signals. The switchgear cabinet 9 is connected by way of a data cable 13 to a control facility 12. The switchgear cabinet 9 is controlled by the control facility 12. The control facility 12 has a display device 15, at which current operating data and parameter settings can be displayed. A data processing facility 11 processes operator inputs, supplies preset x-ray programs for predefined recording situations, and generates the control signals for the switchgear cabinet 9. The data processing facility 11 accesses a diaphragm memory 14, which has information for adjusting the second diaphragm formed by the perforated disks 19 and 22. The diaphragm memory 14 has information, based on which, when an operator or x-ray program selects a required contour for the x-ray beam 6, the setting for the respective perforated disk 19, 22 is determined, which allows the selected contour to be best achieved.

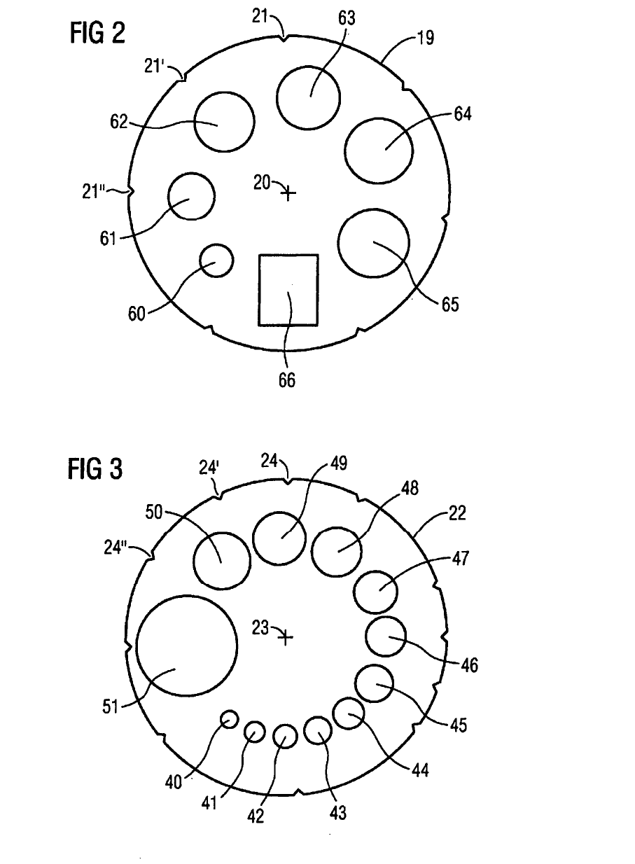

As shown in FIG. 2, the first perforated disk 19 of the second diaphragm includes a circular periphery and is mounted in a rotatable manner in a centrally disposed axis support 20. The first perforated disk 19 of the second diaphragm can be installed in a simple manner within the radiation diaphragm 30 using the axis support 20.

The first perforated disk 19 of the second diaphragm includes a plurality of diaphragm apertures 60, 61, . . . , 66 of differing forms and sizes, allowing diverse contouring of an x-ray beam. The first perforated disk 19 is made from a material that does not allow the passage of x-ray radiation, for example, lead or another element with a high atomic number, so that a passing x-ray beam is blocked by the perforated disk 19 and can only pass through a respective diaphragm aperture 60, . . . , 66. The diaphragm aperture 60, . . . , 66 is simply be positioned in the x-ray beam.

The differing forms and sizes of the diaphragm apertures 60, . . . , 66 are only shown schematically. The round apertures can, for example, have a respective diameter of 10 mm, 14 mm, 18 mm, 19 mm, 20 mm and 21 mm. Other individual sizes can similarly be realized. The first perforated disk 19 of the second diaphragm includes a rectangular diaphragm aperture 66. The form and size of the rectangular diaphragm aperture 66 are tailored to an x-ray film cassette in such a manner that this can be fully exposed by the x-ray radiation defined using the rectangular diaphragm aperture 66. To allow precise positioning of a respective diaphragm aperture 60, . . . , 66 as controlled by positioning facilities, positioning marks 21, 21′, 21″, . . . are provided on the periphery of the perforated disk 19. The position of each positioning mark 21, 21′, 21″, . . . correlates to the position of a respective diaphragm aperture 60, . . . , 66. The positioning marks 21, 21′, 21″, . . . enclose the same midpoint angles or arcs as the positions of the diaphragm apertures 60, . . . , 66. A specific position of a respective positioning mark 21, 21′, 21″, . . . corresponds to a specific position of the respectively associated diaphragm aperture 60, . . . , 66. This allows precise machine positioning.

As shown in FIG. 3, the second perforated disk 22 is embodied in a similar manner to the first perforated disk 19 described above in FIG. 2 and can also be mounted in a rotatable manner in a central axis support 23. The second perforated disk 22 has a plurality of diaphragm apertures 40, . . . , 51 in differing sizes and positioning marks 24, 24′, 24″, . . . that correlate to the respective position. The individual sizes of the diaphragm apertures 40, . . . , 51 are shown schematically and can have diameters, for example, from 5 mm to 16 mm in 1 mm steps and can have a diameter of 30 mm for the largest diaphragm aperture 51.

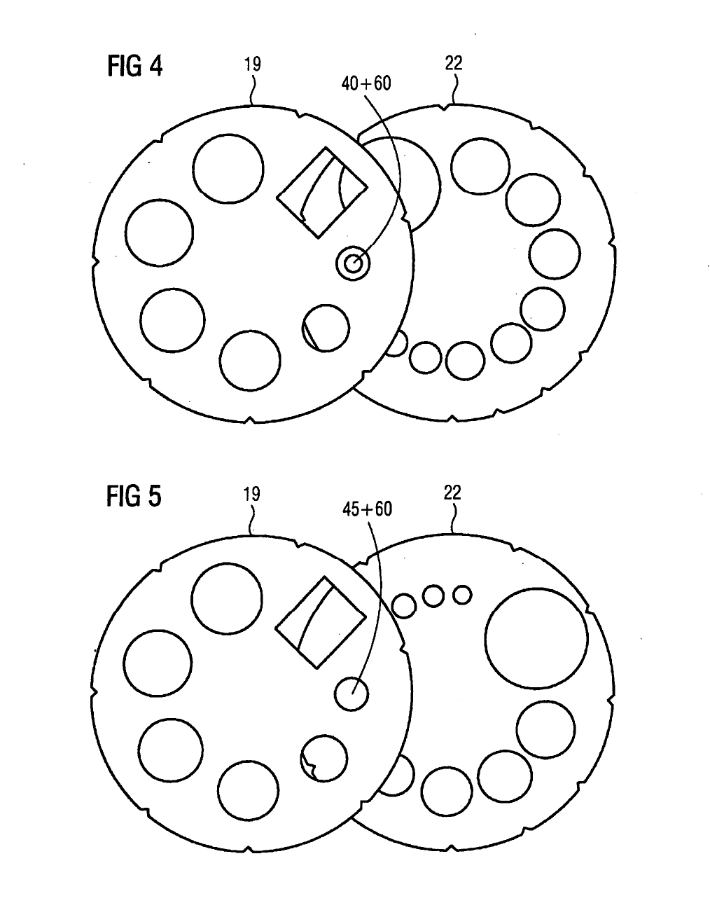

FIG. 4 shows a schematic top view of the interaction of the perforated disks 19 and 22, which are disposed in a mutually overlapping manner in the direction of the beam path in the radiation diaphragm 30. The perforated disks 19 and 22 should be disposed in the beam so that the midpoint of the mutual overlap of the two disks is disposed in the midpoint of the beam. In the rotation position shown in FIG. 4 the diaphragm aperture 60 of the perforated disk 19 and the diaphragm aperture 40 of the perforated disk 22 are positioned at the midpoint of the mutual overlap of the two disks. Since the diaphragm aperture 40 has the smaller diameter, it predetermines the contour and diameter of the x-ray radiation beam passing through it. The diaphragm aperture 40 is significance to the diaphragm setting actually achieved. In the embodiment of the perforated disks shown, the diaphragm apertures 41, 42, 43 and 44 of the perforated disk 22 have smaller diameters than the diaphragm aperture 60 of the perforated disk 19. With concentric positioning with the diaphragm aperture 60, the diaphragm apertures 41, 42, 43 and 44 of the perforated disk 22 would be respectively determining factors in respect of the effective diaphragm setting.

FIG. 5 shows a positioning of the perforated disks 19 and 22. The diaphragm aperture 45 of the perforated disk 22 and the diaphragm aperture 60 of the perforated disk 19 are disposed at the midpoint of the overlap. The diaphragm aperture 60 has a smaller diameter compared with the diaphragm aperture 45 and is a determining factor for the x-ray beam passing through it. The diaphragm aperture 60 represents the effective diaphragm setting.

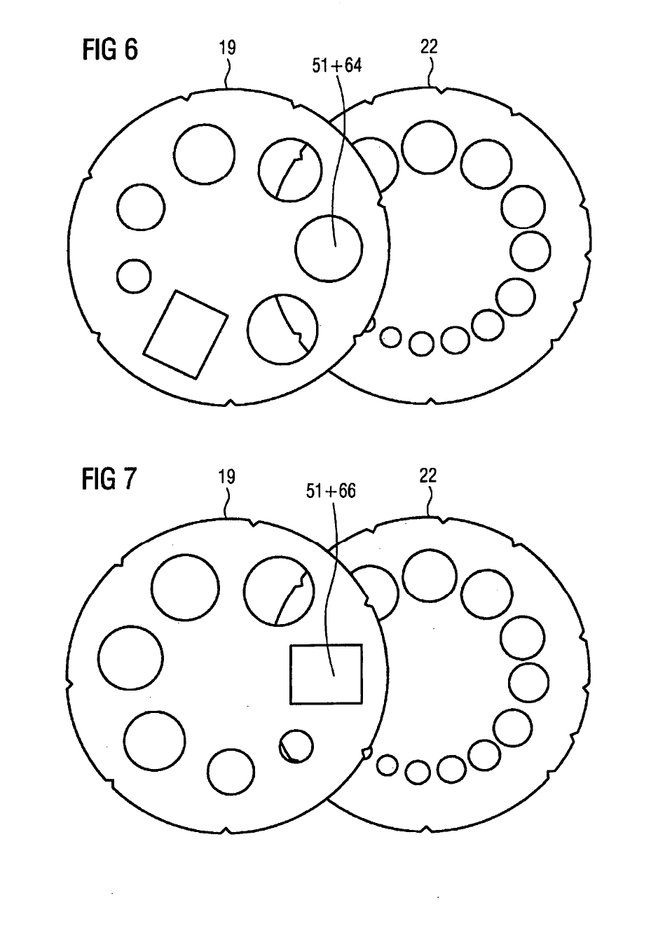

FIG. 6 shows a further positioning of the perforated disks 19 and 22. The diaphragm apertures 51 and 64 are positioned at the midpoint of the x-ray beam. Because of its comparatively small diameter, the diaphragm aperture 64 is a determining factor for the effective diaphragm setting.

FIG. 7 shows a further positioning of the perforated disks 19 and 22. The diaphragm apertures 51 and 66 are positioned at the midpoint of the x-ray beam. The rectangular diaphragm aperture 66, the contour and dimensions of which can, for example, be matched to an x-ray film cassette to be exposed, is disposed completely within the periphery of the diaphragm aperture 51 and has smaller dimensions than the diaphragm aperture 51. The rectangular diaphragm aperture 66 is a determining factor for the effective diaphragm setting.

As shown in FIGS. 4 to 7 and described above, the selected distribution of the diaphragm sizes over the two perforated disks 19 and 22 and their mutual overlap allows an extremely compact structure of the diaphragm. The diaphragm ensures a wide diversity of variation of the possible effective diaphragm settings. The relatively dense arrangement of the diaphragm apertures 40, . . . , 51, 60, . . . , 66 on the respective perforated disks 19 and 22 in particular is clear, allowing efficient utilization of the respective perforated disk surface.

The present embodiments relate to a radiation diaphragm 30 for an x-ray facility 1 with at least one radiation defining element, which is mounted in a displaceable manner and embodied as a perforated disk. The radiation defining element is mounted in a displaceable manner in a plane perpendicular to a beam to be defined 6 and has a plurality of differently formed diaphragm apertures 40, . . . 51, 60, . . . 66 for respectively differently contoured definition of the beam 6. The radiation defining element can, for example, be embodied as an essentially rotationally symmetrical perforated disk. In one embodiment, there are two radiation defining elements, which are disposed in a mutually overlapping manner in the direction of the beam to be defined 6.

Various embodiments described herein can be used alone or in combination with one another. The forgoing detailed description has described only a few of the many possible implementations of the present invention. For this reason, this detailed description is intended by way of illustration, and not by way of limitation. It is only the following claims, including all equivalents that are intended to define the scope of this invention.

1. A radiation diaphragm for an x-ray facility comprising:
a radiation defining device,
wherein the radiation defining device is mounted in a displaceable manner in a plane perpendicular to a beam and includes a plurality of different diaphragm apertures for differently contoured definition of the beam.

2. The radiation diaphragm as claimed in claim 1, wherein the radiation defining device extends in an essentially flat manner.

3. The radiation diaphragm as claimed in claim 1,
wherein the radiation defining device is mounted in a rotatable manner in the plane perpendicular to the beam.

4. The radiation diaphragm as claimed in claim 1, wherein the radiation defining device is a perforated disk.

5. The radiation diaphragm as claimed in claim 4, wherein the perforated disk includes a round periphery.

6. The radiation diaphragm as claimed in claim 1,
wherein the radiation defining device has positioning marks, which are disposed so that the radiation defining device can be positioned based on their position in such a manner that a respective diaphragm aperture is disposed in the beam.

7. The radiation diaphragm as claimed in claim 6, wherein the positioning marks are disposed on the periphery of the round perforated disk.

8. The radiation diaphragm as claimed in claim 1,
wherein there are at least two radiation defining devices and the radiation defining devices mutually overlap in the direction of the beam.

9. The radiation diaphragm as claimed in claim 8, wherein the radiation defining devices are disposed so that the beam passes through one diaphragm aperture of each radiation defining device.

10. The radiation diaphragm as claimed in claim 8, wherein each radiation defining device has at least two diaphragm apertures, and
wherein each diaphragm aperture can be disposed within the periphery of at least one diaphragm aperture of the other radiation defining device.

11. An x-ray facility comprising:
a radiation diaphragm that includes a plurality of different diaphragm apertures that are operable to define the beam in different contours,
wherein the radiation diaphragm is displaceable in a plane perpendicular to a beam.

12. The x-ray facility as claimed in claim 11,
wherein the radiation diaphragm includes a first perforated radiation defining device that includes at least one aperture, and a second perforated radiation defining device that includes at least one aperture; and
wherein the first and second perforated disks are operative to be moved to provide different contours of the beam.

13. The x-ray facility as claimed in claim 12, comprising: a data processing facility and a diaphragm memory that includes data,
wherein the data processing facility has access to the diaphragm memory and the diaphragm memory data, the data processing facility being operable to determine a position of at least one of the radiation defining device.

14. The x-ray facility as claimed in claim 13, wherein the data processing facility is connected to the radiation diaphragm and is operable to control the positioning of at least one of the radiation defining devices in the suitable position.

15. The radiation diaphragm as claimed in claim 9,
wherein each radiation defining device has at least two diaphragm apertures, and
wherein each diaphragm aperture can be disposed within the periphery of at least one diaphragm aperture of the other radiation defining device.

16. The x-ray facility as claimed in claim 12, wherein the first and second perforated radiation defining devices include a circular periphery.

17. The x-ray facility as claimed in claim 13, wherein the data processing facility is operable to determine the position based on the position of the diaphragm memory data.
